(19) United States
(12) Patent Application Publication
(10) Pub. No.: US 2010/0278174 A1
(43) Pub. Date: Nov. 4, 2010

(54) Method and Arrangement for Network Roaming of Corporate Extension Identities

(75) Inventors: Leif Isaksson, Tyreso (SE); Kjell Roxnas, Vargon (SE); Jan Akerman, Molnbo (SE)

Correspondence Address: COATS & BENNETT, PLLC, 1400 Crescent Green, Suite 300, Cary, NC, 27518, US

(73) Assignee: TELEFONAKTIEBOLAGET LM ERICSSON (PUBL), Stockholm (SE)

(21) Appl. No.: 12/808,479

(22) PCT Filed: Dec. 20, 2007
(86) PCT No.: PCT/EP2007/064379

§ 371 Date: Jun. 16, 2010

(51) Int. Cl. H04L 12/66

(52) U.S. Cl. 370/352

(57) ABSTRACT

The present invention is a method, a node and a user terminal for roaming in an IP based main network. A node, in a sub-network of said main network receives a registration request from a user terminal belonging to said sub-network, wherein the registration request comprises an unique extension identity. The node is configured to determine whether said unique extension identity belongs to the sub-network of the requesting user terminal. In case said extension identity belongs to another sub-network, the node will request a routing server of the sub-network for an IP-address of a home sub-network for said unique extension identity. The routing server is configured to respond the IP address of the requested home sub-network. The node will transmit the IP address to the requesting user terminal for enabling the transmission of a registration request using the IP address to the home sub-network from said user terminal.

### TECHNICAL FIELD

The present invention relates to network roaming. More particularly, the present invention relates to a method for roaming in an IP-based corporate network, a node in a local corporate network within an IP-based corporate network, a method in a node, comprising a gate keeper, in a local corporate network of an IP based corporate network, and a terminal for logging on to a local corporate network.

### BACKGROUND

In today's global enterprise world many corporations are widely spread over the world and have local corporate offices in many locations. Some of these corporations have a corporate communication network to ensure communications within the corporation. These corporate communication networks can be IP based and voice communication between terminals within the corporate network is then voice over IP (VoIP). The corporate network may consist of at least one local area network. Many separate local area networks, e.g. one for each local corporate office, can also be interconnected by an IP backbone network. The employees in the corporation can be provided with a unique extension for logging into the corporate network.

Employees within the corporation will often be travelling for various activities to different local corporate offices. During these visits to local corporate offices the employees among others need to communicate with their home corporate office and make external phone calls. For these purposes they can use the terminals within the corporate network at a visited local office. There is also a need for employees to be able to answer calls placed to their extensions at their home office when visiting another local office than their home office. One way to achieve this is to forward their extensions to a specific terminal in a visited local corporate office, where the employee presently is located. However if the employee visits another local corporate office the employees extension has to be forwarded to another terminal in said visited local corporate office. There would therefore be an advantage if employees could receive calls to their extensions on any terminal in the corporate network without the need to forward their extension to a specific terminal in advance from their home office.

Forwarding of an employee's extension will not be a flexible solution when an employee is visiting many different local corporate offices, as forwarding has to be handled and managed from the home office terminal and public branch exchange PBX, to an extension that has to be known when the employee leaves his/her home office.

Further, in an IP based network the extension identities are personal and therefore, a visiting employee may have to borrow another employee's extension for a while. Therefore, it would be favorable if an employee could use the extension identity wherever he or she works within the corporation.

In order for the employees to be able to answer calls to their phone number on any terminal in the corporate network the employee's home office has to know at which terminal in the corporate network the employee presently is located. The corporate network also has to authenticate that it is not an unauthorised person that is trying to get access to the corporate network using an employee's phone number.

### SUMMARY

The object of the present invention is to provide an automatic network roaming and log-on procedure for a user, e.g. a subscriber and/or employee, via an IP terminal, e.g. IP phone, to log on from any IP-based sub-network, such as a local corporate network, of a IP-based main network, e.g. a corporate network, to a home sub-network of the user, subscriber and/or employee.

The problem to be solved is how to identify a correct IP address of the home sub-network to which a unique extension identity of the user is belonging.

The problem is solved by configuring a node in the sub-networks, a node comprising the gate keeper of the sub-network, to perform a network roaming method according to the present invention.

One aspect of the present invention is a method for roaming in an IP based main network wherein users have unique extension identities and unique logon passwords in said main network. A node, comprising a gate keeper, in a sub-network of said main network receives a registration request from a user terminal belonging to said sub-network, wherein the registration request comprises an unique extension identity. The node is configured to determine whether said unique extension identity belongs to the sub-network of the requesting user terminal. In case said extension identity belongs to another sub-network than the node's sub-network, the node will request a routing server of the sub-network for an IP-address of a home sub-network for said unique extension identity. The routing server is configured to respond the IP address of the requested home gate keeper. The node will transmit the IP address to the requesting user terminal for enabling the transmission of a registration request using the IP address to the home sub-network of said unique extension identity from said user terminal.

Further one aspect of the present invention is a node in a sub-network within an IP-based main network for network roaming in said main network wherein users have unique extension identities and unique logon passwords in said main network. A node, comprising a gate keeper, in a sub-network of said main network is configured to receive a registration request from a user terminal belonging to said sub-network, wherein the registration request comprises an unique extension identity. The node is configured to determine whether said unique extension identity belongs to the sub-network of the requesting user terminal. In case said extension identity belongs to another sub-network than the node's sub-network, the node is configured to request a routing server of the sub-network for an IP-address of a home sub-network for said unique extension identity. The routing server is configured to respond the IP address of the requested home gate keeper. The node is further configured to transmit the IP address to the requesting user terminal for enabling the transmission of a registration request using the IP address to the home sub-network of said unique extension identity from said user terminal.

Further one aspect of the present invention is a method in a node, comprising a gate keeper, in a sub-network within an IP-based main network for network roaming in said main network wherein users have unique extension identities and unique logon passwords in said main network. The node is configured to receive a registration request, which comprises an unique extension identity. If the sub-network is the home sub-network for the received extension identity, said method further comprises the steps of
determining whether said unique corporate extension is already registered in the node;
check registration/log on state of the unique extension identity in case said unique extension identity is already registered in the node;
disconnecting active calls in case there are calls active on the unique corporate extension;
sending an un-registration request towards a user terminal registered with the unique corporate extension for logging off said terminal;
logging on said user terminal by registering the terminal in the home gatekeeper.

Different other embodiments of the present invention is described in the detailed description and the dependent claims enclosed in the text and drawings hereafter.

One advantage of the present invention is that a user does not need to know or remember the IP address of the sub-network, or the IP addresses of all sub-networks of the main-network, in which the user usually uses when making IP phone-calls. The IP address may also be changed without the users of the sub-network or main network have to be informed and updated. The IP addresses of new sub-networks or new IP addresses of old sub-networks will be easily updated by the owner or operator of the main network in certain records, e.g. routing servers, in the sub-networks and main network.

Further advantages and features of embodiments of the present invention will become apparent when reading the following detailed description in conjunction with the drawings.

### BRIEF DESCRIPTION OF THE DRAWINGS

FIG. 1 is a simplified block diagram of an IP based corporate network according to an exemplary embodiment of the present invention.

FIG. 2 is a schematic block scheme illustrating a first local corporation network and a second local corporation network according to an embodiment of the present invention.

FIG. 3 is a flowchart that illustrates a method for network roaming in a corporate network according to the present invention.

FIG. 4 illustrates an exemplary block diagram of a node in a local corporate network for network roaming in an IP based corporate network according to an embodiment of the present invention.

FIG. 5 is a flowchart illustrating an embodiment of a method in a local corporate network for network roaming in a corporate network according to the present invention.

FIG. 6 illustrates an exemplary block diagram of a terminal e.g. an IP phone, a PC (personal computer), etc, according to an embodiment of the present invention.

### DETAILED DESCRIPTION

The present invention will now be described in more details hereinafter with reference to the accompanying drawings, in which preferred embodiments of the invention are shown. This invention may, however, be embodied in many different forms and should not be construed as limited to the embodiments set forth herein; rather, these embodiments are provided so that this disclosure will be thorough and complete, and will fully convey the scope of the invention to those skilled in the art. In the drawings, the same reference signs refer to the same or equivalent elements.

The present invention relates to a network, here called a main network, comprising a number of sub-networks, each sub-network being a part of the main network or in other way closely related to the main network. In the following description, the present invention will be described by means of a corporate network comprising a number of local corporate networks. The corporate network and the sub-networks should be considered as non-limiting example of a main network and its sub-networks.

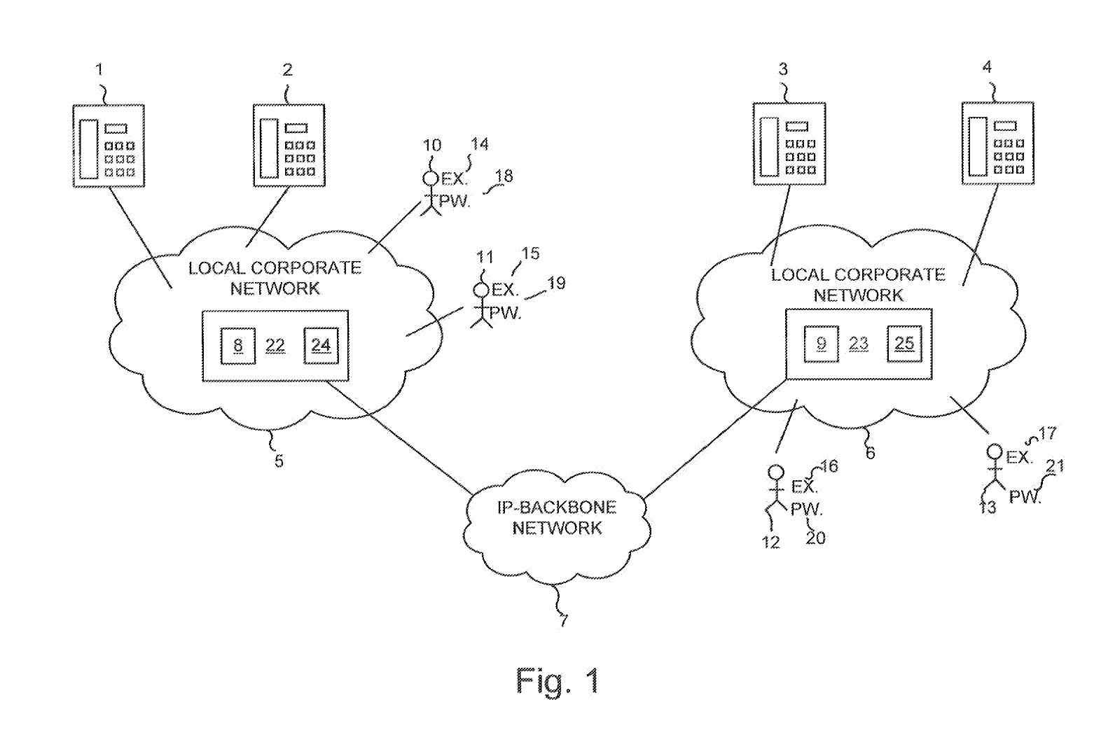

Referring to FIG. 1 there is illustrated a simplified block diagram of an IP based corporate network according to an exemplary embodiment of the present invention. As shown in FIG. 1 the corporate network 100 consists of two local corporate networks 5, 6 interconnected by an IP-backbone network 7. For instance, the first local corporate network 5 can be a local corporate network in Sweden and the second local corporate network 6 can be a local corporate network in Australia. An IP-based (Internet Protocol based) network 7 interconnects the two local corporate networks 5, 6. Said IP network can be the Internet or an IP backbone network 7 and is used by the corporation for data communication between local corporation offices. One or several user terminals 1, 2, 3, 4, . . . have each one communication access to the corporate network 100. The user terminals 1, 2 communicate via the first local corporate network 5, and the user terminals 3, 4 communicate via the second local corporate network 6. As illustrated in FIG. 1, each local corporate network 5, 6 comprises a Private Branch eXchange (PBX) 22, 23, one first PBX 22 serving the first local corporate network 5, and one second PBX 23 serving the second local corporate network 6. Each PBX assists when VoIP calls are made between terminals within a local corporate network, and between terminals in two separate local corporate networks. Another function of an PBX in each local corporate network is to operate as an access node for a local corporate network to an IP network 7. The corporate network 100 has several subscribers 10-13, even called users, which preferably are employees of the corporation. In the exemplary embodiment of the invention according to FIG. 1, each subscriber/user 10-13 has an unique corporate extension 14-17, which is used for calling a certain user/subscriber. An unique corporate extension is for instance a phone number or network number. In FIG. 1, the employees 10-13 all have a home office where they can be reached by a phone call during their working day. The home office for some of the employees 10, 11 is the first local corporate network 5 and the home office for other employees 12, 13 is the second local corporate office 6. All the unique corporate extensions for the employees/subscribers/users are grouped, listed and associated to different local corporate networks, i.e. some of the unique corporate extensions, e.g. 14,15, belong to the first corporate network 5 and other unique corporate extensions, e.g. 16, 17, belong to the second local corporate network 6.

A gate keeper is an entity in a corporate network based on the H.323 protocol standard which among others performs address translation between employees' phone numbers in the corporate network and IP addresses. The H.323 standard provides one suit of protocols which can be used to provide communication services in an IP based corporate network. A gatekeeper may also be adapted to perform authentication of the subscribers in the corporate network. In the exemplary embodiment of a corporate network according to FIG. 1 there are a number of gate keepers of which only two gate keepers 8, 9 are illustrated. The first gate keeper 8 is associated with PBX 22, wherein the gate keeper and the PBX is considered to logically form a node of the first local corporate network 5. The second gate keeper 9 is associated with PBX 23, wherein the gate keeper and the PBX is considered to logically form a node of the second local corporate network 6. In the exemplary embodiment of the invention according to FIG. 1, it is the gate keeper entities that are configured to keep track of which unique corporate extensions belonging to its local corporate network, where the gate keeper is located. The gate keeper 8 is configured to keep track of a set of unique corporate extensions belonging to the local corporate network 5, and correspondingly for the gate keeper 9 and the set of unique corporate extension belonging to the local corporate network 6.

The local office, e.g. the head office of the corporation, for the employees 10, 11 is considered as their local home office served by their local home corporate network 5. Each employee and subscriber is supposed to belong to certain local home office, or a local first office, and each of the other local corporate offices are considered to be an employees local second office, or local visited office when visiting such local second office.

Each unique corporate extension 14-17 in the corporate network 100 is also associated with a password 18-21 that among others is used to authenticate the employees when they are logging in to the corporate network 100. Each PBX 22, 23 is also associated with routing servers 24, 25 that provides the capability to store IP routing information and alternative routing information for the network in order to route calls to the required destination. When a subscriber is logged on to the system and wants to place a call to another extension in the corporate network it is the routing servers that provides routing information to the extension which the subscriber is trying to reach.

When a user, or subscriber/employee, wants to use a terminal, e.g. IP phone, for making phone calls, the terminal has to be logged on to the gate keeper of the local corporate network. The terminal may be provided with a logon/logoff key for actuating an automatic logon process, which now will be described. When a user pushes the logon key, the terminal is set to send a request to a DHCP (Dynamic Host Configuration Protocol) server for an IP address and other stored information relevant for the terminal. DHCP is a protocol used by networked devices (clients) to obtain various parameters necessary for the clients to operate in an Internet Protocol (IP) network. By using this protocol, system administration workload greatly decreases, and devices can be added to the network with minimal or no manual configurations. The DHCP server will respond with a temporary terminal IP address for the terminal and an IP address for an Installation Server (IS) to the terminal. The terminal then sends a request for a gate keeper to logon. The Installation Server is configured to identify the terminals IP address and will respond with a first choice (default) gate keeper IP address, predefined in the Installation Server. Further, the IS may automatically forward updating information and/or new software for the terminal.

After having received the gate keeper IP address, the terminal will be able to send a Registration Request to the indicated gate keeper, which will reply with a identification inquiry back to the terminal. Said identification inquiry will be presented on the terminal display. The user, in this case, an employee of the local office will key in the employee's phone number, which is considered as a unique corporation extension identity. The gate keeper is configured to check if the phone number is known for the gate keeper and, may optionally perform an authentication procedure. When the phone number is accepted, the terminal is logged-on to the gate keeper for further use.

It should be noted that there are several different ways of realizing a corporate network and that FIG. 1 and the description above merely constitutes one example. Further embodiments of the present invention will now be described in more details based on the corporate network in FIG. 1.

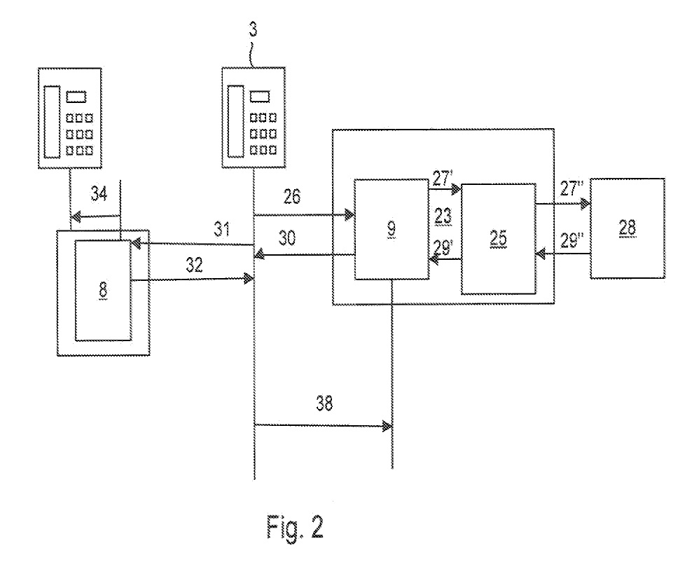

FIG. 2 is a schematic block scheme illustrating a first local corporation network 5 and a second local corporation network 6 visited by an corporation employee 10 (see FIG. 1), whose local home corporation network is the first network 5. Both the local home corporate network 5 and the local visited corporate network 6 are parts of a corporate network 100. The local home corporate network 5 involves a PBX 22 that comprises a gate keeper 8. Terminals of the local home corporate office, like phone terminal 1, is adapted to be connected to the PBX and the gate keeper by a logon procedure. The local visited corporate network 6 involves a PBX 23 that comprises a gate keeper 9. Terminals of the local visited corporate office, like phone terminal 3, is correspondingly adapted to be connected to the PBX and the gate keeper by an employee/subscriber logging on. Further, the gate keeper 9 is configured to communicate with a routing server 25 via a suitable protocol interface. The routing server 25 is configured to communicate with a corporate routing server 25 via a protocol interface.

Referring to FIG. 2, message communication are illustrated according to an exemplary embodiment of the present invention for network roaming in an IP based corporate network. It is here assumed that the subscriber 10 which has the home office 5, for instance in Sweden, is visiting another corporate local office 6, in for instance Australia. The subscriber 10 now, according to the invention, wants the possibility to answer calls made to his/her unique corporate extension from a terminal 3 in the local corporate office 6 in Australia. The subscriber 10 first has to log on to the local visited corporate network 6 from the terminal 3.

In order to log on to the corporate network from the terminal 3 the subscriber inputs his/her unique corporate extension 14 (see FIG. 1) on the terminal 3. The terminals then transmits a registration request 26 comprising the unique corporate extension 14 inputted by the subscriber 10 to the gate keeper 9 in the local corporation network 6. After reception of the registration request 26, the gate keeper 9 determines if the unique corporate extension identity belongs to the local corporate network 6. In the exemplary embodiment of the invention according to FIG. 2, the gate keeper 9 is configured to compare the unique corporate extension identities to a stored/listed set of identities and to determine whether the unique corporate extension 14 belongs to another local corporate network within the corporate network of the corporation. In case authentication is enabled, the gate keeper is configured to request authorization to access the local corporate network 6, an employee has to input his/her password to be able to logon to the network. In this exemplary embodiment of the invention authentication is enabled. But since the gate keeper 9 determines, as a result of the comparison, that the unique corporate extension 14 belongs to another network within the corporate network, the password request for the extension is disabled and the subscriber does not at this stage have to input the password 18 associated with the unique corporate extension 14. Since the unique corporate extension 14 belongs to another network the subscriber 10 is not able to log on to the corporate network and the gate keeper 9 therefore has to find the home network for the unique corporate extension 14. The gate keeper 9 sends a request 27′ to a routing server 25 for an IP address of a home gate keeper (HGK) 8 associated with said unique corporate extension identity 14 for the visiting subscriber/employee. The IP address of the home gate keeper 8 is responded to the gate keeper 9 in a respond message 29′.

In case no IP address for the home gate keeper (HGK) associated with the unique corporate extension 14 is found in the routing server 25, a request 27″ for an IP address for a home gate keeper associated with the unique corporate extension 14 is sent from the routing server 25 to a corporate routing server 28. In case the IP address for the home gate keeper 8 associated with the unique corporate extension 14 can not be found in the corporate routing server 28, a message 29″ is transmitted from the corporate routing server 28 to the local routing server 25 indicating that the IP address for the home gate keeper 8 associated with the unique corporate extension 14 can not be found. The local routing server generates and transmits a negative response message 29′ to the gate keeper 9, which generates and transmits a message 30 indicating to the terminal 3 that the registration request 26 is rejected.

If the IP address for the home gate keeper 8 is found in the corporate routing server 28, the message 29″ transmitted to the local routing server 25 contains the IP address. The local routing server 25 generates and transmits a positive response message 29′ to the gate keeper 9, which generates and transmits a message 30 containing the requested IP address to the terminal 3.

In case the gate keeper 9 has responded the IP address in the message 30 to the terminal 3, the terminal transmits a registration request 31 to the home gate keeper 8 using the IP address. In case the unique corporate extension 14 is already registered in the home gate keeper 8 the registration/log on state of the unique corporate extension is checked. If there are active calls on the unique corporate extension 14 the active calls are disconnected and a un-registration request 34 is sent towards a terminals. The home gate keeper then transmits a password request 32 to the terminal 3. After receiving a password 18 from the terminal 3 the home gate keeper 8 authenticates the login password and logs on the terminal 3 by registering the terminal 3 in the home gate keeper 8.

According to one embodiment of the invention, the home gate keeper 8 is also configured to handle emergency call request from terminals 3 and 4 that are remotely logged in differently compared to emergency call requests from terminals 1 and 2 in the local corporate network 5 associated with the home gate keeper 8. If an emergency call request 35 is received in the gate keeper 8 from the terminal 3 a message 36 is transmitted from the home gate keeper 8 to the terminal 3 ordering the terminal 3 to place the emergency call request 37 to a gate keeper 9 in the local corporate network 6 where the terminal 3 is located. If an emergency call requests is received from that is remotely logged in the home gate keeper 8 will also reject all incoming calls to the unique corporate extension 14. Another method for handling emergency calls from terminals 3 and 4 when they are remotely logged is to transmit a message 38 to the terminal 3 informing the terminal 3 that it is remotely logged in and that the terminal 3 should place emergency call requests 37 to the gate keeper 9 in the local corporate network 6.

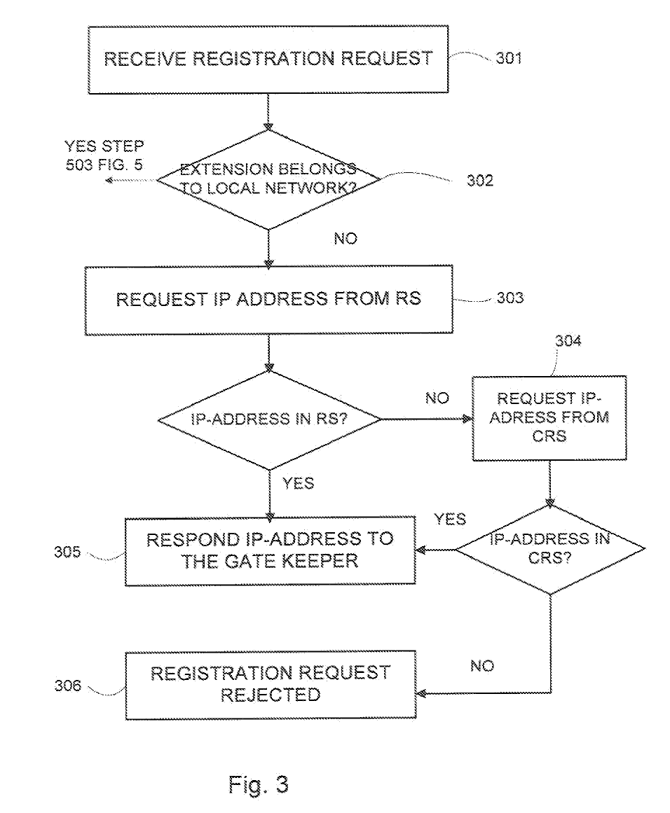

FIG. 3 is a flowchart that illustrates a method for network roaming in a corporate network according to the present invention. In step 301a registration request comprising a unique corporate extension is received in a gate keeper in a local corporate network. The unique corporate extension can for instance be a phone number or a network number. The local corporate network could for instance be a local corporate network in Australia. The registration request is received from a terminal that belongs to the local corporate network. In the next step 302, the node determines whether the unique corporate extension identity is registered to the local corporate network or to another local corporate network. A unique corporate extension identity belonging to the local corporate network may identify a person having an employment at the local corporate office. If the unique corporate extension belongs to another local network different from the employee's home local corporate network, a routing server in the local network is requested, in step 303, for an IP address of a home gate keeper for the unique corporate extension. In case a password is required to log on to the local corporate network a password request for the terminal is also disabled in the gate keeper, in step 303, in case the extension belongs to the another network than the local network.

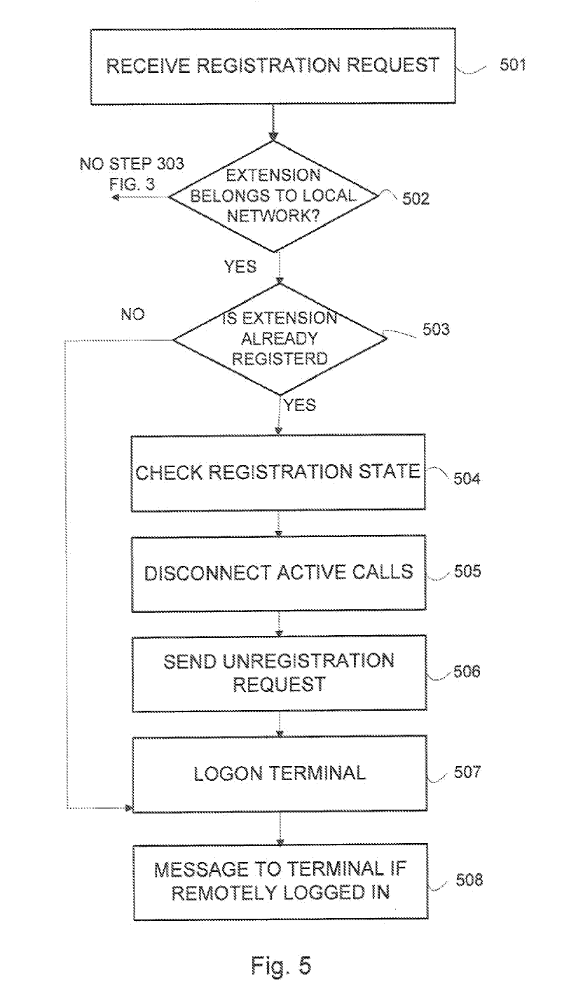

If the IP address is found in the routing server, the IP address for the requested home gate keeper is responded to the gate keeper, in step 305, which transmits the IP address to the terminal to make it possible for the terminal to transmit a registration to the home gate keeper associated with the unique corporate extension using the IP address for the home gate keeper. If the IP address is not found in the routing server the IP address for the requested home gate keeper, a request for the IP-address is transmitted to a corporate routing server, in step 304. If the IP-address is found in the corporate routing server the IP-address is responded to the gate keeper, in step 305, which transmits the IP address to the terminal to make it possible for the terminal to transmit a registration request to the home gate keeper associated with the unique corporate extension using the IP address for the home gate keeper. If no IP address for a home gate keeper associated with the unique corporate extension is found in the corporate routing server, in step 304, a message is received in the routing server, in step 306, indicating that the IP address to the home gate keeper can not be found. A message is then transmitted in step 306 to the terminal indicating that the registration request is rejected. If it is determined in step 302 that the extension belongs to the local network, the method continues with in step 503 in FIG. 5.

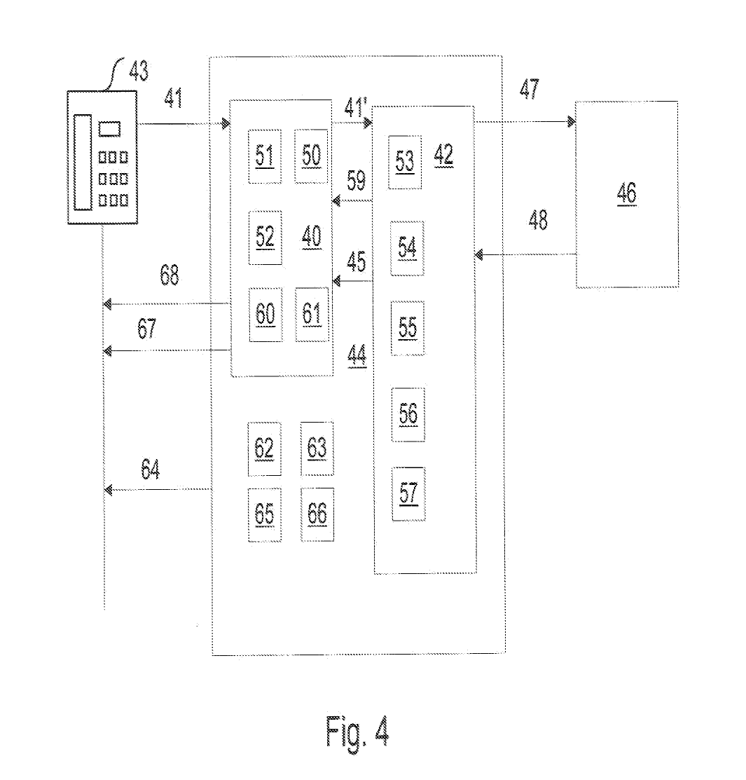

FIG. 4 illustrates an exemplary block diagram of a node 44 in a local corporate network for network roaming in an IP based corporate network according to an embodiment of the present invention. The node could for instance be a public branch exchange PBX. The gate keeper 40 has means 50 for receiving a registration request 41 comprising a unique corporate extension from a terminal 43 within the corporate network. The gate keeper is also configured to determine using means 51 whether the unique corporate extension belongs to the local corporate network or to another local network within the corporate network different from the local corporate network. In case the unique corporate extension belongs to another local corporate network different from the local corporate network the gate keeper 40 has means 52 to request, in a message 41′ from a routing server 42 in the node an IP address of a home gate keeper associated with unique corporate extension. If the IP address is found in the routing server 42, the routing server 42 has means 53 to transmit the IP address in a message 59 to the gate keeper 40 which transmits the IP address to the terminal 43 in a message 67. If the IP address to the home gate keeper associated with the unique corporate extension can not be found in the routing server 42 the routing server 42 has means 54 to request in a message 47 the IP address associated with the unique corporate extension from a corporate routing server 46. If the IP address associated with the unique corporate extension is found in the corporate routing server 46 the routing server 42 has means 57 to receive from the routing server the IP address, in a message 48, for the home gate keeper associated with the unique corporate extension. The routing server 42 then transmits the IP address using means 53 in a message 59 to the gate keeper 40 which transmits the IP address to the terminal 43 in a message 67. If the IP address associated with the unique corporate extension can not be found in the corporate routing server 46 the routing server 42 has means 55 to receive from the corporate routing server the message 48 indicating that the IP address to the home gate keeper associated with the unique corporate extension can not be found. The routing server 42 then transmits a message 45 using means 56 to the gate keeper which indicates that the IP address for the home gate keeper associated with the unique corporate extension can not be found. The gate keeper in response to the message 45 transmits a message 68 which indicates that the registration request is rejected. In case a password is required to log on to the local corporate network the gate keeper 40 also has means 60 to disable a password request for the terminal 43 in case the extension belongs to another network different from the local network.

If the gate keeper 40 determines using means 51 that the unique corporate extension belongs to the local corporate network the gate keeper 40 determines using means 61 whether the unique corporate extension is already registered in the node. In case the unique corporate extension is already registered in the node it has means 62 for checking the registration/log on state of the unique corporate extension. If there are active calls on the unique corporate extension the node is also configured for disconnecting the active calls using means 65 and sending an un-registration request using means 63 towards a terminal registered with the unique corporate extension for logging of the terminal using the unique corporate extension.

The gate keeper then process the registration request 41 and logs on the terminal 43 by registering the terminal in the gate keeper 40. If the terminal 43 is a terminal that belongs to another network different from the local corporate network which is determined by means 66 in the node, the node sends a message 64 to the terminal 43 informing the terminal that it is remotely logged in and that the terminal should place emergency call requests to a node in the another local corporate network where the terminal is located.

FIG. 5 is a flowchart that illustrates an embodiment of a method in a local corporate network for network roaming in a corporate network according to the present invention. In step 501 a registration request comprising a unique corporate extension is received in a gate keeper in a local corporate network. The unique corporate extension can for instance be a phone number or a network number. The local corporate network could for instance be a local corporate network in Australia. In the next step 502 the node determines whether the unique corporate extension belongs to the local network or to another network. If the unique corporate extension belongs to the local corporate network the node checks in step 503 if the unique corporate extension is already registered in the node. If the unique corporate extension is not registered in the node the method continues in step 507. If the unique corporate extension is already registered in the node the registration/log on state of the unique corporate extension is checked in step 504 to determine if there are any active calls on the extension. Any active calls are disconnected in step 505 in case there are any active calls. A terminal already registered is un-registered, in step 506, by sending an un-registration request towards the terminal that is registered with the unique corporate extension for logging of the terminal. The terminal that sent the registration request that was received in step 501 is then logged on in step 507 by registering the terminal in the home gate keeper. After the terminal has been logged on the node determines, in step 508, if the terminal belongs to the local network of if the registration request received in step 501 was transmitted from a terminal that belongs to another local network within the corporate network. If the terminal belongs to another network a message is transmitted from the node, in step 508, informing the terminal that it is remotely logged on and that the terminal should place emergency call requests to a node in the another local corporate network where the terminal is located. If it is determined in step 502 that the extension does not belong to the local network the method continues in step 303 in FIG. 3.

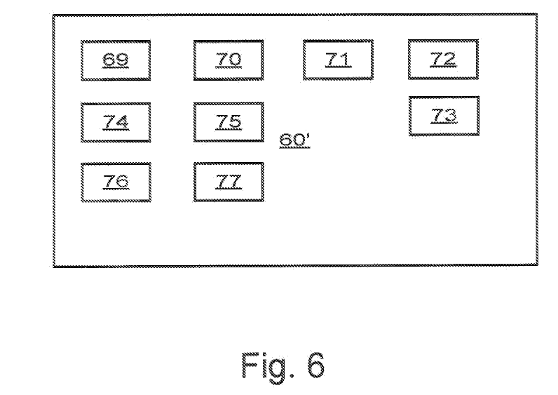

FIG. 6 illustrates an exemplary block diagram of a terminal 60, e.g. an IP phone, a PC (personal computer), etc, in a local corporate network used for network roaming in an IP based corporate network according to en embodiment of the present invention.

The terminal has a controller 74, with storage means for storing computer software and data to the controller operation and functions, which controls the terminal and its regular functions beside the means for implementing the present invention. An input unit 75 comprises input interface circuits, e.g. for handling the input signals and digital information generate by a microphone and/or push buttons. The terminal also has output means 76 comprising output interface circuits, e.g. for handling the output signals and digital information generated by the terminals different blocks and circuits for presentation by a loudspeaker and/or a display. An interface 77 connects the terminal to the local corporate network. The interface could be a wire connection or a wireless connection. The terminal has means 69 for transmitting a registration request to a gate keeper in the local corporate network comprising a unique corporate extension belonging to another local corporate network. Since the unique corporate extension is associated with another gate keeper the terminal is not able to register in the gate keeper to which the registration request was sent. The terminal is therefore configured for receiving an IP address using means 70 to the home gate keeper associated with said unique corporate extension which was transmitted from the terminal in the registration request. After the IP address is received the terminal 60 is able to transmitting the registration request to the home gate keeper associated with the unique corporate extension using the IP address received from the gate keeper. If the IP address to the home gate keeper associated with unique corporate extension can not be found the terminal is configured to be able to receive a message using means 71 that indicates that said registration request is rejected since the IP address to the home gate keeper can not be found. The terminal 60 has also means 72 and 73 for handling emergency calls according to the present invention. When the terminal is remotely logged in the terminal is configured to receive a message from the home gate keeper using means 72 informing the terminal that it is remotely logged in and that the terminal should place emergency call requests to a node in the local corporate network. To be able to handle emergency calls differently from other telephone numbers the terminal has means 73 for analyzing a dialed number and determine if the number is an emergency number. In case the dialed number is an emergency number the terminal places the emergency call request to a node in the local corporate network.

While the invention has been described in terms of several preferred embodiments, it is contemplated that alternatives, modifications, permutations and equivalents thereof will become apparent to those skilled in the art upon reading of the specifications and study of the drawings. It is therefore intended that the following appended claims include such alternatives, modifications, permutations and equivalents as fall within the scope of the present invention.

1. A method for roaming in an IP based main network wherein subscribers have unique extension identities and unique logon passwords in said main network, said method comprising:
receiving a registration request in a gate keeper in a sub-network within said main network from a terminal belonging to said sub-network, said registration request comprising an unique extension identity;
determining within said gate keeper whether said unique extension identity belongs to said sub-network; and
if said unique extension identity belongs to said sub-network:
requesting a routing server (RS) of said sub-network, an IP address of a home gale keeper (HGK) for said unique extension identity;
responding the IP address of the requested home gate keeper from the routing server to the gate keeper; and
transmitting the IP address from the gate keeper to the terminal for enabling the transmission of a registration request using said IP address to the home gatekeeper (HGK) of said unique extension from said terminal.

2. The method according to claim 1, further comprising, in case no IP address is found by said routing server:
sending a request from the routing server for an IP address of the home gate keeper (HGK) to a main routing server (CRS); and
receiving from said main routing server in the routing server the IP address of the home gate keeper (HGK).

3. The method according to claim 2, further comprising, if no correct IP address is identified by said main routing server (CRS):
receiving in the routing server from the main routing server a message indicating that said corporate extension identity can not be found; and
transmitting a message from the routing server to the terminal indicating that said registration request is rejected.

4. The method according to claim 1, further comprising:
disabling in said gatekeeper (GK) a password request for said unique extension identity in case said extension belongs to another network than said sub-network of the gate keeper.

5. The method according to claim 1, wherein said unique extension identity is a phone number or a network number.

6. The method according to claim 1, wherein the main network is a corporate network, a sub-network is a local corporate network, a main routing server is a corporate routing server, and the unique extension identity is a unique corporate extension identity.

7. A node in a sub-network within an IP-based main network wherein subscribers have unique extension identities and unique logon passwords in said main network, wherein the node comprises:
a gate keeper configured to:
receive a registration request comprising a unique extension identity from a terminal;
determine whether the unique extension identity belongs to the sub-network characterized in that:
request, from a routing server (RS) in the node, an IP address of a home gate keeper (HGK) associated with the unique extension identity in case the unique extension identity belongs to another network than the sub-network of the gate keeper,
transmit the IP address to the terminal for enabling the transmission of a registration request using said IP address to the home gatekeeper (HGK) of the unique extension identity from the terminal,
a routing server configured to provide the IP address of the requested home gate keeper to the requesting gate keeper responsive to the request.

8. The node according to claim 7, wherein the routing server further is configured to:
request an IP address of the home gate keeper (HGK) associated with the unique extension identity from a main routing server (CRS) in case no IP address is found in the routing server; and
receive the IP address from the main routing server.

9. The node according to claim 8, where said routing server (RS) further is configured to:
receive, from the main routing server, a message indicating that said IP address can not be found; and
send a message to the terminal indicating that the registration request is rejected.

10. The node according to claim 7, wherein said gate keeper (GK) further is configured to:
disable a password request for a terminal in case the extension identity belongs to another sub-network than the sub-network of the gate keeper.

11. The node according to claim 7, where the node is public branch exchange (PBX).

12. The node according to claim 7, where the node further is configured to:
determine, in case the unique extension identity belongs to the sub-network, whether the unique extension is already registered in the node;
check registration/log on state of the unique the extension identity in ease the unique the ex tension identity is already registered in the node;
disconnect active calls in case there are calls active on the unique extension;
send an un-registration request towards a terminal registered with the unique extension identity for logging of said first terminal; and
process said registrations request and log on the terminal by registering the terminal in the gatekeeper.

13. The node according to claim 12, where the node further is configured to:
determine whether the terminal belongs to the sub-network;
transmit from the node a message to the terminal, in case said terminal belongs to another sub-network, informing the terminal that it is remotely logged on and that the terminal should place emergency call requests to a node in the other sub-network where the terminal is located and usually registered.

14. The node according to claim 7, wherein the main network is a corporate network, a sub-network is a local corporate network, a main routing server is a corporate routing server, and the unique extension identity is a unique corporate extension identity.

15. A method implemented by a gate keeper in a node in a sub-network of an IP based main network, wherein subscribers have unique extension identities and unique logon passwords in said main network, wherein the method comprises the step of:
receiving a registration request at said gate keeper (OK), said registration request comprising an unique extension identity, characterized ill that if the sub-network and gate keeper is the home sub-network and home gate keeper, respectively, for the received extension identity, said method further comprises the steps of:
determining whether the unique extension identity is already registered in the node;
check registration/log on state of the unique extension identity in case said unique extension identity is already registered in the node;
disconnecting active calls in case there are calls active on the unique extension;
sending an un-registration request towards a terminal registered with the unique extension identity for logging of said terminal;
logging on the terminal by registering the terminal in the home gatekeeper.

16. The method according to claim 15, further comprising:
transmitting a message to the logged on terminal, in case said terminal belongs to another sub-network, informing the terminal that it is remotely logged on.

17. The method according to claim 15, further comprising:
transmitting a message to the logged on terminal that the terminal should place emergency call requests to a node in the other sub-network wherein the terminal is located.

18. The method according to claim 15, wherein the main network is a corporate network, the sub-network is a local corporate network, and the unique extension identity is a unique corporate extension identity.

19. A terminal for logging on to a sub-network within an IP based main network wherein subscribers have unique extension identities and unique logon passwords in the main network, wherein the terminal is configured to:
transmit a registration request to a gate keeper in the sub-network comprising a unique extension identity belonging to another sub-network, characterized in that the terminal further is configured to:
receive from the gate keeper an IP address of a home gate keeper associated with the unique extension identity; and
transmit the registration request to the home gate keeper using the IP address.

20. The terminal according to claim 19, wherein the terminal further is configured to:
receive a message indicating that said registration request is rejected since the unique extension identity has no registered gate keeper IP address and thereby stop the logon procedure.

21. The terminal according to claim 20, wherein the terminal further is configured to:
receive a message informing the terminal that it is remotely logged on and that the terminal should place emergency call requests to a node in the sub-network.

22. The terminal according to claim 19, wherein said terminal further is configured to:
analyze a dialed number and in case the number is an emergency number place the emergency call request to a node in the sub-network.

23. The terminal according to claim 19, wherein the main network is a corporate network, a sub-network is a local corporate network, and the unique extension identity is a unique corporate extension identity.
